(19) United States
(12) Patent Application Publication
(10) Pub. No.: US 2022/0393319 A1
(43) Pub. Date: Dec. 8, 2022

(54) BATTERY PACK AND VEHICLE INCLUDING BATTERY PACK

(71) Applicants: TOYOTA JIDOSHA KABUSHIKI KAISHA, Toyota-shi (JP); KABUSHIKI KAISHA TOYOTA JIDOSHOKKI, Kariya-shi (JP); YAZAKI CORPORATION, Tokyo (JP)

(72) Inventors: Yutaka INOUE, Toyota-shi (JP); Hiromi UEDA, Kariya-shi (JP); Keizo KOTERA, Toyota-shi (JP)

(73) Assignees: TOYOTA JIDOSHA KABUSHIKI KAISHA, Toyota-shi (JP); KABUSHIKI KAISHA TOYOTA JIDOSHOKKI, Kariya-shi (JP); YAZAKI CORPORATION, Tokyo (JP)

(21) Appl. No.: 17/830,516

(22) Filed: Jun. 2, 2022

(30) Foreign Application Priority Data
Jun. 7, 2021 (JP) 2021-095285

(51) Int. Cl. H01M 50/569; H01M 50/583; H01M 50/591

(52) U.S. Cl. CPC H01M 50/569; H01M 50/583; H01M 50/591

(57) ABSTRACT

A battery pack includes: a battery stack; a high-voltage equipment component including a fuse; a first cable configured to connect a first connection portion of the battery stack and the high-voltage equipment component; a second cable configured to connect a second connection portion of the battery stack and the high-voltage equipment component; an equipment cover covering the high-voltage equipment component; and a low-voltage equipment component. The first cable and the second cable are disposed to extend in different directions from each other between the battery stack and the equipment cover. The low-voltage equipment component is disposed to face a surface of the battery stack on which the first connection portion is located, and is offset with respect to the first connection portion.

### CROSS-REFERENCE TO RELATED APPLICATION

This application claims priority to Japanese Patent Application No. 2021-095285 filed on Jun. 7, 2021, incorporated herein by reference in its entirety.

### BACKGROUND

### 1. Technical Field

The present disclosure relates to a battery pack and a vehicle including the battery pack.

### 2. Description of Related Art

Japanese Unexamined Patent Application Publication No. 2010-212166 (JP 2010-212166 A) discloses a lithium-ion secondary battery system including: an battery assembly composed of a plurality of lithium-ion secondary cells; and a plurality of fuses each provided for each of the lithium ion secondary cells.

### SUMMARY

In this related art described in JP 2010-212166 A, when, for example, a high-voltage equipment component including a fuse is placed in front of a battery stack in the longitudinal direction of a vehicle, two cables (positive cable and negative cable) connecting the high-voltage equipment component and the battery stack run in parallel. Therefore, in the related art, the two cables may be caught between the battery stack and a cover for the high-voltage equipment component in case of a vehicle collision, and may be directly short circuited. In this case, the fuse is not located in the short circuit path, and the flow of the current may not be interrupted.

A battery pack according to a first aspect of the present disclosure includes: a battery stack; a high-voltage equipment component including a fuse; a first cable configured to connect a first connection portion of the battery stack and the high-voltage equipment component; a second cable configured to connect a second connection portion of the battery stack and the high-voltage equipment component; an equipment cover configured to cover the high-voltage equipment component; and a low-voltage equipment component. The first cable and the second cable are disposed to extend in different directions from each other between the battery stack and the equipment cover. The low-voltage equipment component is disposed to face a surface of the battery stack on which the first connection portion is located, and is offset with respect to the first connection portion.

According to the battery pack of the first aspect of the present disclosure, an increase in size of the battery pack can be reduced.

A vehicle according to a second aspect of the present disclosure may include the battery pack. The equipment cover may be disposed to face a side surface of the battery stack that extends in a lateral direction of the vehicle.

According to the vehicle of the second aspect of the present disclosure, even when a short circuit occurs in case of a vehicle collision, the fuse can interrupt the flow of a large current. Moreover, an increase in size of the battery pack can be reduced.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is an external perspective view of a battery stack included in a battery pack according to an embodiment;

FIG. 2 is a plan view of the battery pack according to the embodiment;

FIG. 3 is a side view of the battery pack according to the embodiment; and

FIG. 4 is a side view of a vehicle according to the embodiment.

### DETAILED DESCRIPTION OF EMBODIMENTS

In the vehicle of the second aspect of the present disclosure, the high-voltage equipment component may include a first terminal and a second terminal, the first cable may be configured to connect to the first terminal, and the second cable may be configured to connect to the second terminal. The first cable and the second cable may be disposed to extend in opposite directions to each other between the battery stack and the equipment cover.

In the vehicle of the second aspect of the present disclosure, the surface of the battery stack on which the first connection portion is located may be a first side surface of the battery stack that extends in a longitudinal direction of the vehicle, and the second connection portion may be located on a second side surface of the battery stack that extends in the longitudinal direction of the vehicle and that faces the first side surface.

In the vehicle of the second aspect of the present disclosure, the low-voltage equipment component may be disposed so as not to overlap the first connection portion in a vertical direction of the vehicle.

Hereinafter, an embodiment of the present disclosure will be described with reference to the drawings.

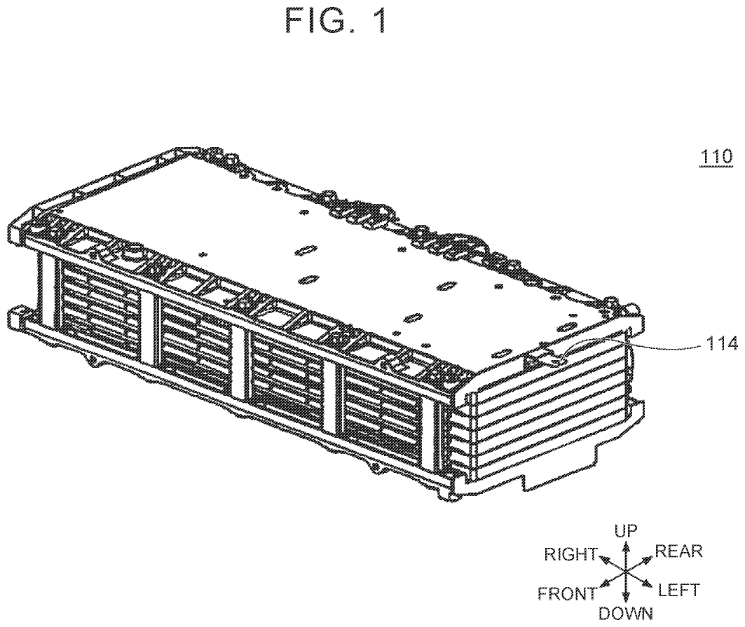

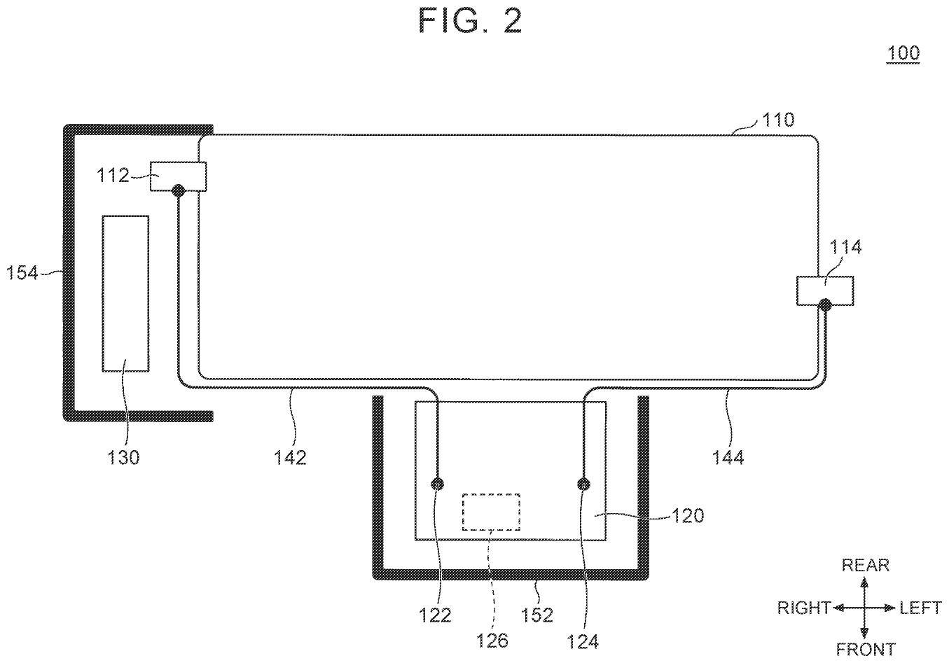

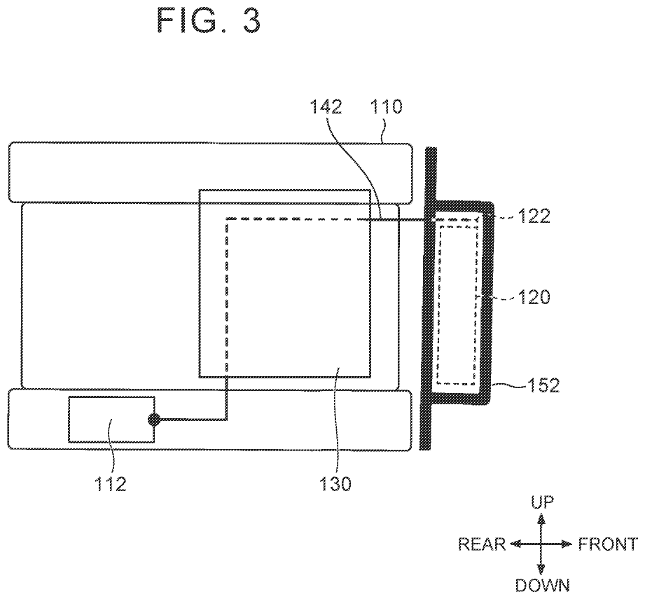

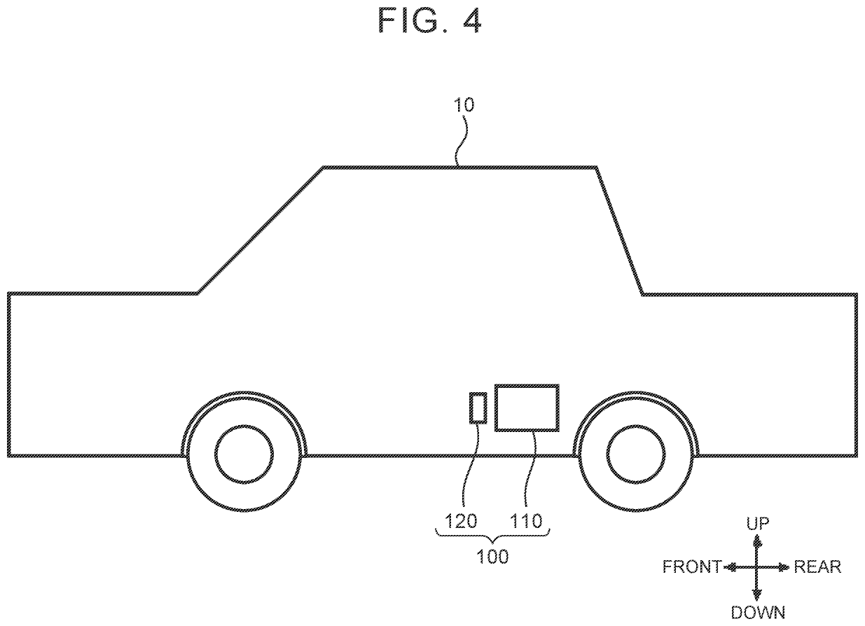

FIG. 1 is an external perspective view of a battery stack 110 included in a battery pack 100 according to an embodiment. FIG. 2 is a plan view of the battery pack 100 according to the embodiment. FIG. 3 is a side view of the battery pack 100 according to the embodiment. FIG. 4 is a side view of a vehicle 10 according to the embodiment. The figures are schematic drawings, and the size of each member varies among the figures.

For example, the battery pack 100 shown in FIGS. 2 and 3 is mounted on the vehicle 10 with a drive motor such as a hybrid electric vehicle or a battery electric vehicle as shown in FIG. 4, and is used as a power source that supplies power for the drive motor. The mounting position and orientation of the battery pack 100 on the vehicle 10 shown in FIG. 4 are merely illustrative, and are not limited to this example. Regarding the battery pack 100, configurations other than a battery stack 110 and a high-voltage equipment component 120 that will be described later are not shown in FIG. 4.

In FIGS. 1, 2, 3, and 4, “UP” refers to the upward direction of the vehicle 10 with the battery pack 100, and “DOWN” refers to the downward direction of the vehicle 10 with the battery pack 100. Similarly, “LEFT” refers to the leftward direction as viewed from an occupant in a cabin of the vehicle 10 with the battery pack 100, and “RIGHT” refers to the rightward direction as viewed from an occupant in the cabin of the vehicle 10 with the battery pack 100. Similarly, “FRONT” refers to the forward direction of the vehicle 10 with the battery pack 100, and “REAR” refers to the rearward direction of the vehicle 10 with the battery pack 100.

These terms are also used in the following description.

### Configuration of Battery Pack 100

As shown in FIGS. 2 and 3, the battery pack 100 includes the battery stack 110, the high-voltage equipment component 120, a low-voltage equipment component 130, a first cable 142, a second cable 144, a fuse 126, and a first equipment cover 152, and a second equipment cover 154.

Although each of the first equipment cover 152 and the second equipment cover 154 has an upper surface and a lower surface in the vertical direction of the vehicle 10 (i.e., the direction perpendicular to the paper of FIG. 2), the upper and lower surfaces are not shown in FIG. 2. The second equipment cover 154 is not shown in FIG. 3.

The battery stack 110 is a rechargeable battery, namely a so-called secondary battery. The battery stack 110 can supply high voltage power. The battery stack 110 includes multiple cells (not shown) electrically connected in series. The cells are, for example, nickel metal hydride battery cells or lithium-ion battery cells. The battery stack 110 has a configuration in which the cells are arranged next to each other in one direction. The battery stack 110 is thus substantially in the shape of a rectangular parallelepiped with its longitudinal direction matching the direction in which the cells are arranged. Particularly in the present embodiment, as shown in FIGS. 2 and 4, the battery stack 110 is mounted on the vehicle 10 such that the lateral direction of the battery stack 110 corresponds to the longitudinal direction of the vehicle 10 and the longitudinal direction of the battery stack 110 corresponds to the lateral direction of the vehicle 10 as viewed in plan from above the vehicle 10. The battery stack 110 includes a positive terminal 112 and a negative terminal 114. The positive terminal 112 is an example of the “first connection portion,” and protrudes from the lower end of the right side surface of the battery stack 110. The negative terminal 114 is an example of the “second connection portion,” and protrudes from the upper end of the left side surface of the battery stack 110. That is, in the present embodiment, the positive terminal 112 and the negative terminal 114 are located on the pair of opposite side surfaces (right and left side surfaces) of the battery stack 110.

The high-voltage equipment component 120 is an equipment component that operates with high-voltage power supplied from the battery stack 110. In the present embodiment, the high-voltage equipment component 120 is located on the front side surface of the battery stack 110. The high-voltage equipment component 120 includes a positive terminal 122 and a negative terminal 124. The positive terminal 122 is located on the right side of the high-voltage equipment component 120. The negative terminal 124 is located on the left side of the high-voltage equipment component 120.

The first cable 142 is a high-voltage cable connected to the positive terminal 122 of the high-voltage equipment component 120 and the positive terminal 112 of the battery stack 110. The positive terminal 122 of the high-voltage equipment component 120 is therefore connected to the positive terminal 112 of the battery stack 110 via the first cable 142.

The second cable 144 is a high-voltage cable connected to the negative terminal 124 of the high-voltage equipment component 120 and the negative terminal 114 of the battery stack 110. The negative terminal 124 of the high-voltage equipment component 120 is therefore connected to the negative terminal 114 of the battery stack 110 via the second cable 144.

The low-voltage equipment component 130 is an equipment component that operates with low-voltage power supplied from a battery (not shown) other than the battery stack 110 mounted on the vehicle 10. In the present embodiment, the low-voltage equipment component 130 is located on the right side surface of the battery stack 110.

The fuse 126 is provided in the high-voltage equipment component 120. The fuse 126 is blown when a large current is supplied to the high-voltage equipment component 120. The fuse 126 thus interrupts the flow of the large current to the high-voltage equipment component 120 and protects the high-voltage equipment component 120. The fuse 126 may be provided on the first cable 142 or the second cable 144.

The first equipment cover 152 is a box-shaped (hollow rectangular parallelepiped-shaped) member made of metal and having an opening. The first equipment cover 152 is attached to the front side surface of the battery stack 110 and covers the high-voltage equipment component 120.

The second equipment cover 154 is a box-shaped (hollow rectangular parallelepiped-shaped) member made of metal and having an opening. The second equipment cover 154 is attached to the right side surface of the battery stack 110 and covers the low-voltage equipment component 130.

### Arrangement of First Cable 142 and Second Cable 144

In the battery pack 100 of the present embodiment, as shown in FIG. 2, the first cable 142 and the second cable 144 extend in different directions from each other between the battery stack 110 and the first equipment cover 152.

Specifically, the first cable 142 is extended from the positive terminal 122 of the high-voltage equipment component 120 to the outside on the right side of the first equipment cover 152 through the clearance between the right side surface of the first equipment cover 152 and the front side surface of the battery stack 110. The first cable 142 is then placed along the front side surface and right side surface of the battery stack 110 and connected to the positive terminal 112 on the right side surface of the battery stack 110.

On the other hand, the second cable 144 is extended from the negative terminal 124 of the high-voltage equipment component 120 to the outside on the left side of the first equipment cover 152 through the clearance between the left side surface of the first equipment cover 152 and the front side surface of the battery stack 110. The second cable 144 is then placed along the front side surface and left side surface of the battery stack 110 and connected to the negative terminal 114 on the left side surface of the battery stack 110.

In the battery pack 100 of the present embodiment, the first cable 142 and the second cable 144 are thus arranged so as not to run in parallel. Therefore, in the battery pack 100 of the present embodiment, even when an external force is applied to the first equipment cover 152 in the direction toward the battery stack 110 (i.e., rearward) in case of a vehicle collision and a short circuit occurs with the first cable 142 and the second cable 144 being caught between the first equipment cover 152 and the battery stack 110, the first cable 142 and the second cable 144 will not be directly short circuited. Since the fuse 126 will be present in the short circuit path, the fuse 126 will be blown to interrupt the flow of a large current to the high-voltage equipment component 120 and protect the high-voltage equipment component 120.

### Placement of Low-Voltage Equipment Component 130

As shown in FIG. 3, in the battery pack 100 of the present embodiment, the low-voltage equipment component 130 is offset with respect to the positive terminal 112 of the battery stack 110. Specifically, the low-voltage equipment component 130 is placed so as to face the right side surface of the battery stack 110, and is covered by the second equipment cover 154. As shown in FIG. 3, the low-voltage equipment component 130 is placed offset in an area that does not overlap the positive terminal 112 located in the lower part of the right side surface of the battery stack 110 (i.e., in the middle portion of the right side surface of the battery stack 110), when the battery stack 110 is viewed in plan from the right side.

In the battery pack 100 of the present embodiment, the low-voltage equipment component 130 can thus be placed in the limited space on the right side of the battery stack 110 so as not to interfere with the positive terminal 112. This configuration can reduce an increase in size of the battery pack 100.

Although a preferred embodiment of the present disclosure is described in detail above, the present disclosure is not limited to the embodiment, and various modifications and alterations can be made within the scope of the present disclosure described in the claims.

What is claimed is:

1. A battery pack, comprising:
a battery stack;
a high-voltage equipment component including a fuse;
a first cable configured to connect a first connection portion of the battery stack and the high-voltage equipment component;
a second cable configured to connect a second connection portion of the battery stack and the high-voltage equipment component;
an equipment cover configured to cover the high-voltage equipment component; and
a low-voltage equipment component, wherein:
the first cable and the second cable are disposed to extend in different directions from each other between the battery stack and the equipment cover; and
the low-voltage equipment component is disposed to face a surface of the battery stack on which the first connection portion is located, and is offset with respect to the first connection portion.

2. A vehicle including the battery pack according to claim 1, wherein the equipment cover is disposed to face a side surface of the battery stack that extends in a lateral direction of the vehicle.

3. The vehicle according to claim 2, wherein:
the high-voltage equipment component includes a first terminal and a second terminal;
the first cable is configured to connect to the first terminal;
the second cable is configured to connect to the second terminal; and
the first cable and the second cable are disposed to extend in opposite directions to each other between the battery stack and the equipment cover.

4. The vehicle according to claim 2, wherein:
the surface of the battery stack on which the first connection portion is located is a first side surface of the battery stack that extends in a longitudinal direction of the vehicle; and
the second connection portion is located on a second side surface of the battery stack that extends in the longitudinal direction of the vehicle and that faces the first side surface.

5. The vehicle according to claim 2, wherein the low-voltage equipment component is disposed so as not to overlap the first connection portion in a vertical direction of the vehicle.
